(19) United States
(12) Patent Application Publication
(10) Pub. No.: US 2025/0224855 A1
(43) Pub. Date: Jul. 10, 2025

(54) TERMINAL AND METHOD

(71) Applicant: 17LIVE Japan INC., Tokyo (JP)

(72) Inventors: Masanari KOSHINO, Tokyo (JP); Kazunari YAMAMOTO, Tokyo (JP)

(21) Appl. No.: 19/088,197

(22) Filed: Mar. 24, 2025

Related U.S. Application Data
(63) Continuation of application No. 17/992,679, filed on Nov. 22, 2022.

(30) Foreign Application Priority Data
Mar. 17, 2022 (JP) 2022-043160

(51) Int. Cl. G06F 3/0484

(52) U.S. Cl. CPC G06F 3/0484

(57) ABSTRACT

A terminal includes processors and a memory storing one or more sets of instructions to be executed for: triggering an initial activation of an application program after the application program is installed on the terminal, wherein the initial activation includes: selecting and displaying a first function introducing screen introducing a designated function on a display of the terminal as a currently displayed screen, wherein the designated function is designated upon installing the application program; detecting a swipe to transit the currently displayed screen from the first function introducing screen to a second function introducing screen introducing a different function; and, detecting a tap on the currently displayed screen and displaying on the display a function screen that enables a user to use the function corresponding to the currently displayed screen being tapped.

### CROSS-REFERENCE TO RELATED APPLICATIONS

This application is a continuing application of U.S. patent application Ser. No. 17/992,679, filed on Nov. 22, 2022, and entitled “TERMINAL AND METHOD”, which claims priority to JP2022-043160 filed Mar. 17, 2022. The entire disclosures of the above applications are all incorporated herein by reference.

### BACKGROUND OF THE DISCLOSURE

### Technical Field

The present disclosure relates to a terminal and a method.

### Description of the Related Art

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video distribution services also become popular as storage costs were reduced. And nowadays or in the Reiwa period (2019 to present), with the sophistication of smartphones and further improvements in network speed as typified by 5G, services that enable real-time communication through video, especially live-stream services, are gaining recognition. The number of users of live-stream services is expanding, especially among young people, as such services allow people to share the same good time even when they are in the separate locations from each other.

Live-streaming services are relatively new. This makes value propositions important in order that the live-streaming services acquire more users. Specifically, it is essential to explicitly and comprehensively present the attractiveness and values of live-streaming to users (see, for example, “Key to improve conversion! What is a Value Proposition? From Definition to How to Make It,” Will Cloud Blog, URL: https://willcloud.jp/blog/form/what-is-value-proposition/).

One of the features of live-streaming is that users can be involved in more than one way. Some users live-stream or are distributors, other users view live-streams or are viewers, and other users both distribute and view live-streams. Alternatively, some users are interested in live-streaming by celebrities, and other users desire to participate in events. Since users expect a variety of things from live-streams, the conventional uniform value proposition can hardly attract users.

The above issues are not only found in live-streaming application programs, but can also arise for other multi-functional application programs.

### SUMMARY

In view of the above, one object of the present disclosure is to provide a technology that can increase conversion by offering suitable value propositions for multi-functional application programs.

One aspect of the present disclosure relates to a terminal. The terminal includes one or more processors; and a memory storing one or more sets of instructions configured to be executed by the one or more processors for triggering an initial activation of an application program after the application program is installed on the terminal, wherein the initial activation includes: selecting a first function introducing screen used to introduce a designated function from a plurality of function introducing screens corresponding to a plurality of functions of the application program and displaying only the first function introducing screen on a display of the terminal as a currently displayed screen, wherein the designated function is designated by a user upon installation of the application program and the first function introducing screen is selected based on the designated function; upon detection of a swipe on the currently displayed screen, transitioning the currently displayed screen from the first function introducing screen to a second function introducing screen selected from the plurality of function introducing screens, wherein the first function introducing screen and the second function introducing screen include different start objects and introduce different functions of the application program; and, upon detection of a tap on a start object included in the currently displayed screen, displaying on the display a function screen that enables the user to use the function corresponding to the currently displayed screen that includes the start object being tapped.

Another aspect of the present disclosure also relates to a terminal. The terminal on which an application program is installed in response to a user designating an advertisement showing a first function of a plurality of functions of the application program displayed on a screen of a different program executed by the terminal. The terminal includes: one or more processors; a memory storing one or more sets of instructions configured to be executed by the one or more processors for: at an initial activation of the application program after the application program is installed on the terminal, directly displaying, on a display of the terminal, a first function introducing screen that introduces the first function shown in the advertisement being designated upon installing the application program on the terminal; in response to a swipe made by the user on the first function introducing screen, causing a transition to switch the display from only displaying the first function introducing screen to only displaying a second function introducing screen, wherein the second function introducing screen introduces a second function of the application program and the second function is different from the first function; and, in response to a tapping made by the user on either the first function introducing screen or the second function introducing screen, displaying, on the display of the terminal, a function screen that enables the user to use the first function or the second function of the application program.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

The present disclosure can increase conversion by offering suitable value propositions for multi-functional application programs.

### BRIEF DESCRIPTION OF THE DRAWINGS

FIG. 1 schematically illustrates a configuration of a live-streaming system in one embodiment.

FIG. 2 is a block diagram showing functions and configuration of a user terminal shown in FIG. 1.

FIG. 3 is a block diagram showing functions and configuration of a server shown in FIG. 1.

FIG. 4 is a data structure diagram showing an example of a stream DB in

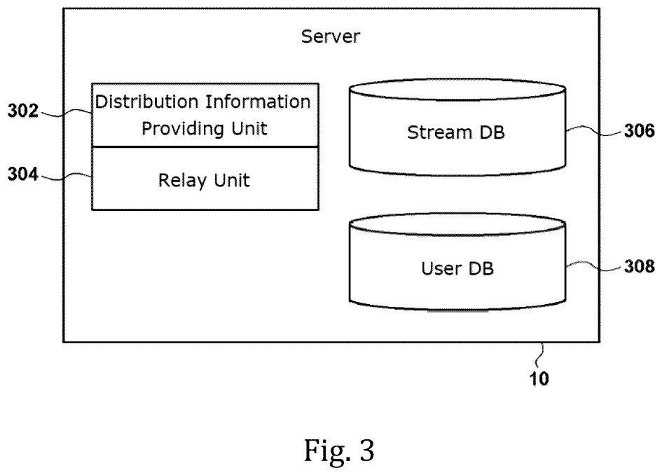

FIG. 3.

FIG. 5 is a data structure diagram showing an example of a user DB in FIG. 3.

FIG. 6 is a flow chart showing a series of steps performed at initial activation of a live-streaming application after the application is installed on a terminal owned by a user.

FIG. 7 shows how screens transition when a user installs and activates a live-streaming application on a terminal owned by the user.

FIG. 8 is a block diagram showing an example of a hardware configuration of an information processing device according to the embodiment.

### DETAILED DESCRIPTION

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

A live-streaming system relating to an embodiment provides for a value proposition of a live-streaming application at initial activation of the live-streaming application after a user installs the application on a terminal owned by the user. The live-streaming system can provide a plurality of function introducing screens, which can transition from one another. Each function introducing screen has a start user interface object (hereafter simply referred to as “the object”) to allow the user to proceed to user registration. In response to a tap on this start object, the user registration is performed. The first screen displayed after completion of the user registration is a function screen that enables the user to use the function corresponding to the function introducing screen displayed when the start object is tapped. For example, if the user goes from a streaming function introducing screen to the user registration, a streaming setting screen is first displayed. If the user proceeds from a viewing function introducing screen to the user registration, a by-genre live streaming selecting screen is first displayed. In this manner, the user can be directly guided to a function screen presenting a function that interests him/her via a value proposition. This can save the user from feeling frustrated when he/she starts using the live-streaming application. This means that value propositions can contribute to reduce user abandonment before completion of user registration. In addition, user abandonment after completion of user registration can be also reduced since the landing page displayed after completion of the user registration can satisfy the user's expectation.

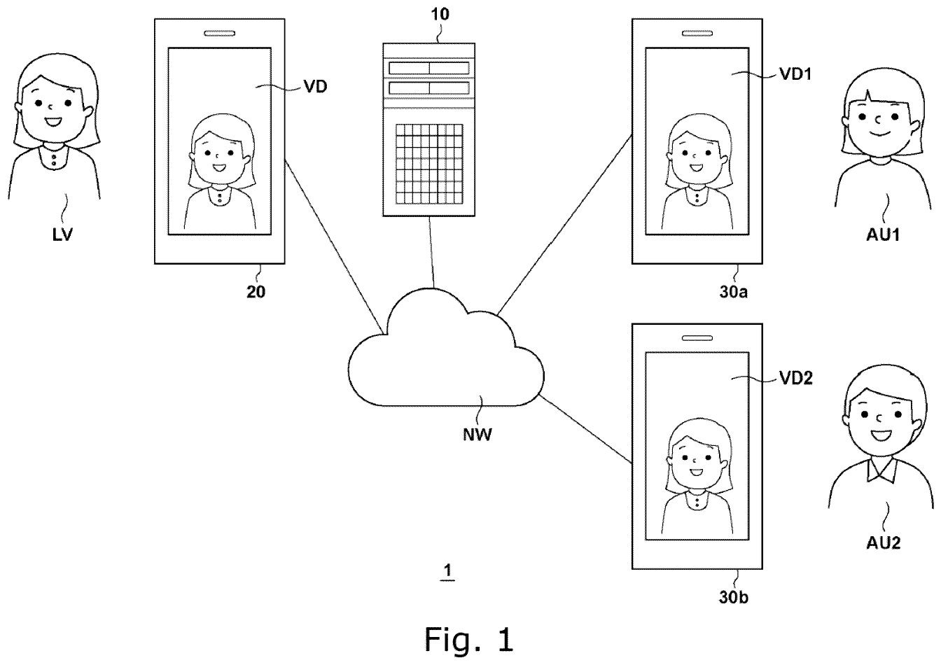

FIG. 1 schematically illustrates a configuration of a live-streaming system 1 in one embodiment. The live-streaming system 1 provides an interactive live-stream service that allows a distributor LV (also referred to as a liver or streamer) and a viewer AU (also referred to as audience) (AU1, AU2, . . . ) to communicate in real time. As shown in FIG. 1, the live-streaming system 1 includes a server 10, a user terminal 20 on the distributor side, and user terminals 30 (30a, 30b, . . . ) on the audience side. The distributor and viewers may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminals 30 are interconnected so as to be able to communicate with each other over the various wired or wireless network NW.

The live-streaming system 1 involves the distributor LV, the viewers AU, an administrator (not shown) who manages the server 10. The distributor LV is a person who broadcasts contents in real time by recording the contents with his/her user terminal 20 and uploading them directly to the server 1. Examples of the contents may include the distributor's own songs, talks, performances, fortune-telling, gameplays, and any other contents. The administrator provides a platform for live-streaming contents on the server 10, and also mediates or manages real-time interactions between the distributor LV and the viewers AU. The viewers AU access the platform at their user terminals 30 to select and view a desired content. During live-streaming of the selected content, the viewers AU perform operations to comment and cheer via the user terminals 30, the distributor LV who is delivering the content responds to such a comment and cheer, and such response is transmitted to the viewers AU via video and/or audio, thereby establishing an interactive communication.

As used herein, the term “live-streaming” or “live-stream” may mean a mode of data transmission that allows a content recorded at the user terminal 20 of the distributor LV to be played and viewed at the user terminals 30 of the viewers AU substantially in real time, or it may mean a live broadcast realized by such a mode of transmission. The live-streaming may be achieved using existing live delivery technologies such as HTTP Live Streaming, Common Media Application Format, Web Real-Time Communications, Real-Time Messaging Protocol and MPEG DASH. The live-streaming includes a transmission mode in which, while the distributor LV is recording contents, the viewers AU can view the contents with a certain delay. The delay is acceptable as long as interaction between the distributor LV and the viewers AU can be at least established. Note that the live-streaming is distinguished from so-called on-demand type transmission, in which contents are entirely recorded and the entire data is once stored on the server, and the server provides users with the data at any subsequent time upon request from the users.

The term “video data” herein refers to data that includes image data (also referred to as moving image data) generated using an image capturing function of the user terminals 20 and 30 and audio data generated using an audio input function of the user terminals 20 and 30. Video data is played back on the user terminals 20 and 30, so that the users can view contents. In this embodiment, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 1, and the video data received and reproduced at the viewer's user terminal are all the same video data.

In the example in FIG. 1, the distributor LV is live-streaming his/her talk. The user terminal 20 of the distributor LV generates video data by recording images and sounds of the distributor LV telling fortune, and the generated data is transmitted to the server 10 over the network NW. At the same time, the user terminal 20 displays a recorded video image VD of the distributor LV on the display of the user terminal 20 to allow the distributor LV to check the live stream currently performed.

The user terminals 30a and 30b of the viewers AU1 and AU2 respectively, who have requested the platform to view the live-stream of the distributor LV, receive video data related to the live-stream (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the talk of the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond the comment, the video and sound of the talk are displayed on the user terminals 30a and 30b of the viewers AU1 and AU2, respectively. This interactive action is recognized as establishment of a conversation between the distributor LV and the viewer AU1. In this way, the live-streaming system 1 realizes the live-streaming that enables the interactive communication, not one-way communication.

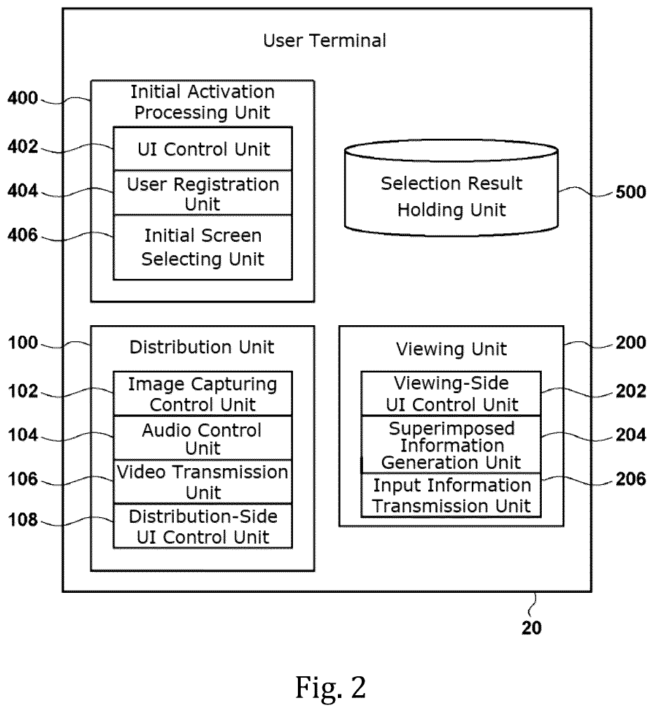

FIG. 2 is a block diagram showing functions and configuration of the user terminal 20 of FIG. 1. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The distributor LV and the viewers AU download and install a live-streaming application program (hereinafter referred to as a live-streaming application), onto the user terminals 20 and 30 from a download site over the network NW. Alternatively, the live-streaming application may be pre-installed on the user terminals 20 and 30. When the live-streaming application is executed on the user terminals 20 and 30, the user terminals 20 and 30 communicate with the server 10 over the network NW to implement various functions. Hereinafter, the functions implemented by (processors such as CPUs of) the user terminals 20 and 30 by running the live-streaming application will be described as functions of the user terminals 20 and 30. These functions are realized in practice by the live-streaming application on the user terminals 20 and 30. In any other embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 20 includes a distribution unit 100 for generating video data by recording the user's image and sound and providing it to the server 10, a viewing unit 200 for acquiring and reproducing the video data from the server 10, an initial activation processing unit 400 for controlling a series of steps involved in initial activation of the live-streaming application after the user installs the live-streaming application on the user's terminal 20, and a selection result holding unit 500 for holding identification information used to identify a function corresponding to a function introducing screen including an object designated by the user at the time of initial activation. The user activates the distribution unit 100 when the user performs live-streaming, and activates the viewing unit 200 when the user views a video. The distribution unit 100 corresponds to the distribution function of the live-streaming application, and the viewing unit 200 corresponds to the viewing function of the live-streaming application. The user terminal in which the distribution unit 100 is activated is the distributor's terminal, i.e., the user terminal that generates the video data, and the user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI for the distributor. The distribution-side UI control unit 108 is connected to a display (not shown in FIG. 2), and displays a video on the display by reproducing the video data that is to be transmitted by the video transmission unit 106. The distribution-side UI control unit 108 displays an operation object or an instruction-accepting object on the display, and accepts inputs from the distributor who taps on the object.

The viewing unit 200 includes a viewing-side UI control unit 202, a superimposed information generation unit 204, and an input information transmission unit 206. The viewing unit 200 receives, from the server 10 over the network NW, the video data related to the live-stream. The viewing-side UI control unit 202 controls the UI for the viewers. The viewing-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewing-side UI control unit 202 is also connected to input means (not shown in FIG. 2) such as touch panels, keyboards, and displays, and obtains user input via the input means. The superimposed information generation unit 204 superimposes a predetermined frame image on an image generated from the video data from the server 10. The frame image includes various objects for accepting inputs from the user, comments entered by the viewers, and information obtained from the server 10. The input information transmission unit 206 transmits the user input obtained by the viewing-side UI control unit 202 to the server 10 over the network NW.

The initial activation processing unit 400 includes a UI control unit 402, a user registration unit 404, and an initial screen selecting unit 406. The UI control unit 402 controls screen transition on the display at initial activation of the live-streaming application after the user installs the live-streaming application on the user terminal 20. The user registration unit 404 handles user registration. The user registration may be handled by employing known user registration techniques, for example, by having the user enter a desired user ID or by allowing the user to sign up using his/her user registration in other services. The initial screen selecting unit 406 refers to the selection result holding unit 500 to select the first function screen to be displayed on the display after completion of the user registration.

FIG. 3 is a block diagram showing functions and configuration of the server 10 of FIG. 1. The server 10 has a distribution information providing unit 302, a relay unit 304, a stream DB 306, and a user DB 308.

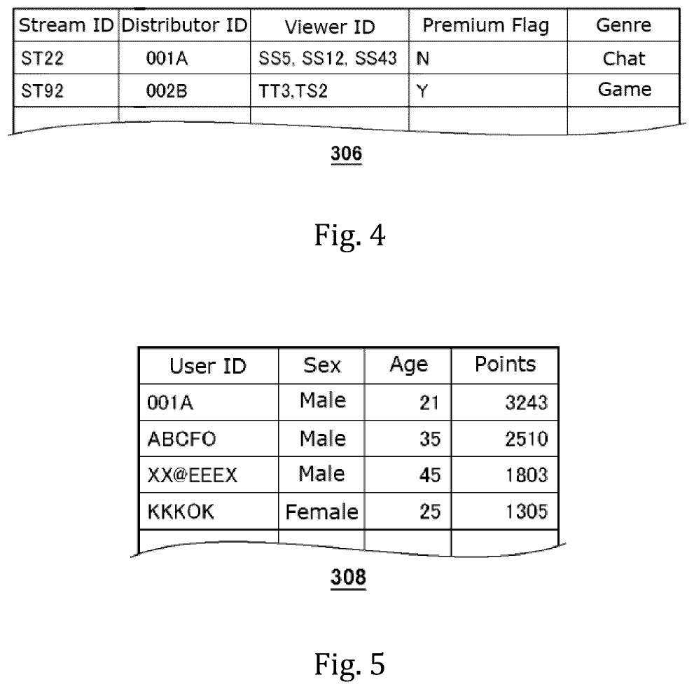

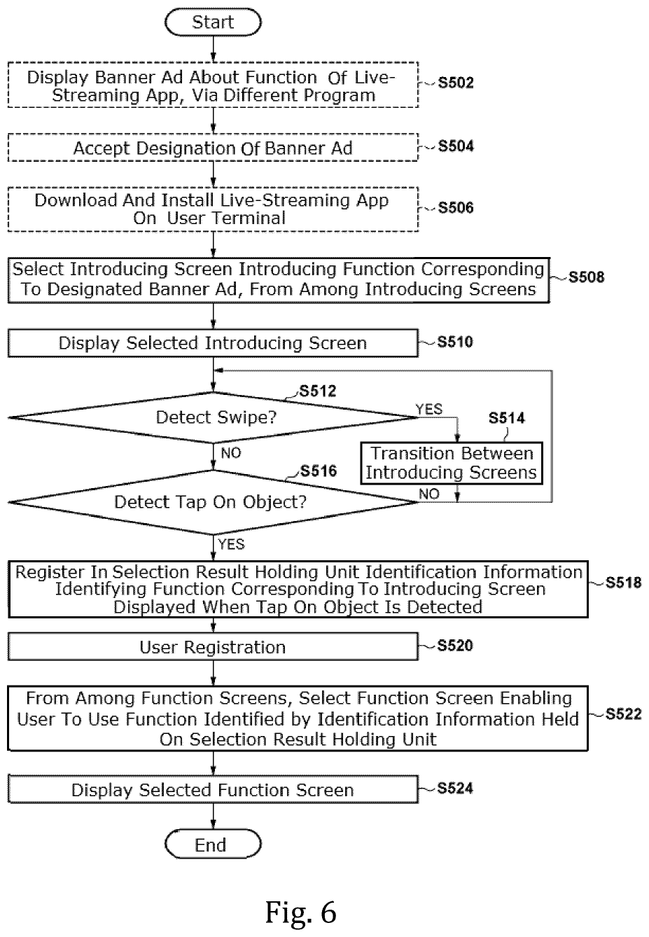

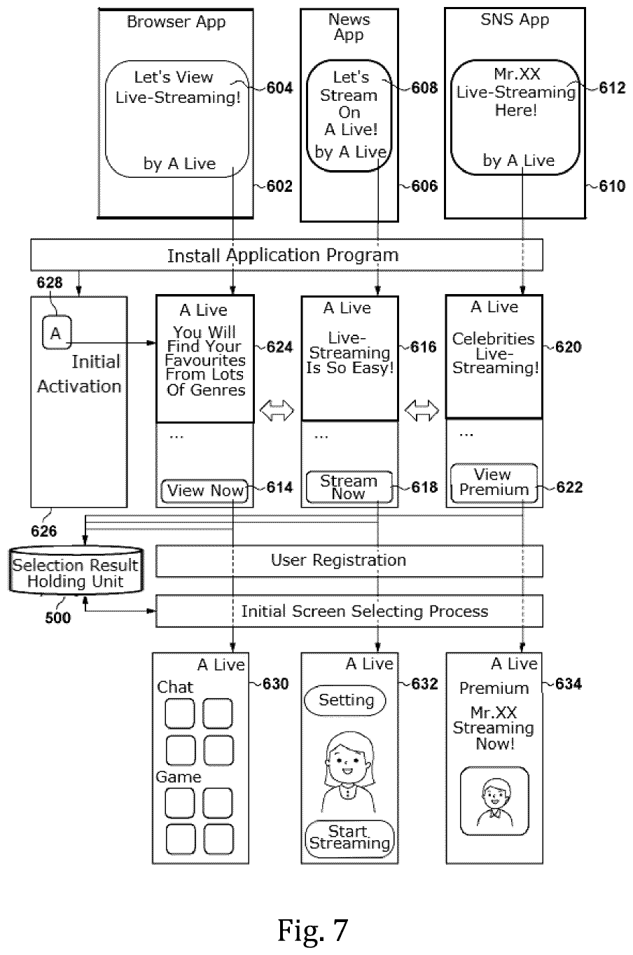

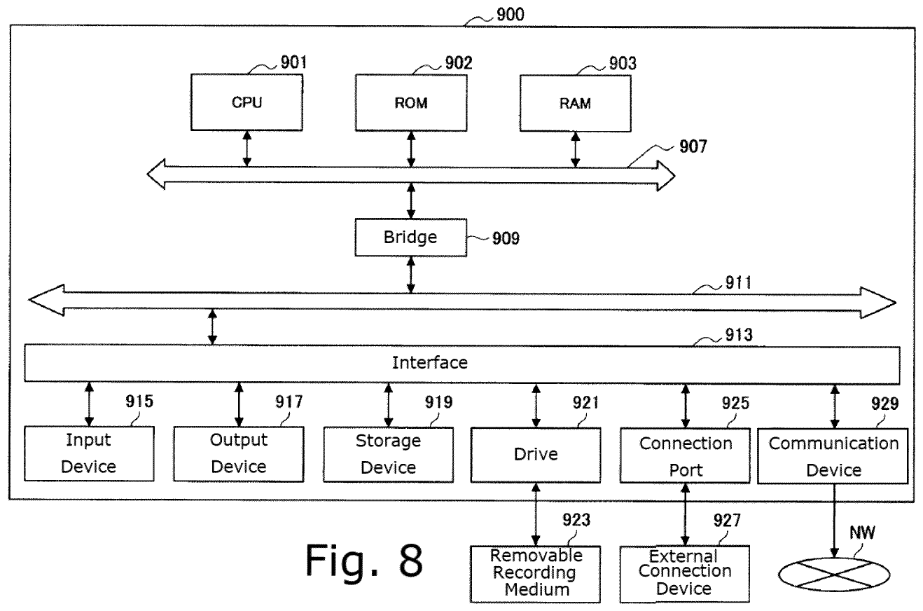

FIG. 4 is a data structure diagram showing an example of the stream DB 306 of FIG. 3. The stream DB 306 holds information regarding live-streams currently taking place. The stream DB 306 stores a stream ID for identifying a live-stream on a live-streaming platform provided by the live-streaming system 1, a distributor ID, which is a user ID for identifying the distributor who provides the live-stream, a viewer ID, which is a user ID for identifying a viewer of the live-stream, a flag indicating whether the live-stream is a premium stream and a genre of the live-stream, in association with each other. In the live-streaming platform provided by the live-streaming system 1 of the embodiment, when a user live-streams, the user becomes a distributor, and when the same user views a live-stream broadcast by another user, the user also becomes a viewer. Therefore, the distinction between a distributor and a viewer is not fixed, and a user ID registered as a distributor ID at one time may be registered as a viewer ID at another time.

Thumbnails of premium streams are displayed on a premium stream selection screen. Thumbnails of live-streams that are not premium streams are displayed on a by-genre live stream selection screen. In other words, the user can view a premium stream by selecting the corresponding thumbnail on a selection screen dedicated for premium streams and can view a non-premium live-stream by selecting the corresponding thumbnail on a different selection screen. Each live-stream is classified into a genre that is designated by the distributor at the start of the live-stream or that is derived from real-time analysis of the live-stream by a machine learning model.

FIG. 5 is a data structure diagram showing an example of the user DB 308 of FIG. 3. The user DB 308 holds information regarding users. The user DB 308 stores a user ID for identifying a user, a sex entered by the user for user registration, an age entered by the user for the user registration, and points owned by the user, in association with each other. The points are an electronic representation of value circulated in the live-streaming platform. When a distributor receives a gift from a viewer during a live-stream, the distributor's points increase by the value of the gift. The points may be used, for example, to determine the amount of reward or money the distributor receives from the administrator of the live-streaming platform.

Referring again to FIG. 2, upon reception of a notification from the user terminal 20 on the distributor side to start a live-stream over the network NW, the distribution information providing unit 302 registers in the stream DB 318 a stream ID identifying this live-stream and a distributor ID identifying the distributor who hosts the live-stream. When receiving a request to provide information about live-streams from the viewing unit 200 of the user terminal 30 on the viewer side over the network NW, the distribution information providing unit 302 retrieves currently available live-streams from the stream DB 306 and makes a list of them. The distribution information providing unit 302 transmits the generated list to the requesting user terminal 30 over the network NW. The viewing-side UI control unit 202 of the requesting user terminal 30 generates a live-stream selection screen based on the received list and displays it on the display of the user terminal 30.

Once the input information transmission unit 206 of the user terminal 30 receives the viewer's selection on the live-stream selection screen, the input information transmission unit 208 generates a distribution request including the stream ID of the selected live-stream, and transmits the request to the server 10 over the network NW. The distribution information providing unit 302 starts providing, to the requesting user terminal 30, the live-stream specified by the stream ID included in the received distribution request. The distribution information providing unit 302 updates the stream DB 306 to include the user ID of the viewer of the requesting user terminal 30 into the viewer IDs of the stream ID.

The relay unit 304 relays the video data from the distributor-side user terminal 20 to the viewer-side user terminal 30 in the live-streaming started by the distribution information providing unit 302. The relay unit 304 receives from the input information transmission unit 206 a signal that represents user input by a viewer during reproduction of the video data. The signal that represents user input may be a gift specifying signal for specifying a gift object displayed on the display of the user terminal 30.

The operation of the live-streaming system 1 with the above configuration will be now described. FIG. 6 is a flow chart showing a series of steps performed at initial activation of the live-streaming application after the live-streaming application is installed on the terminal owned by the user. FIG. 7 shows how screens transition when the user installs and activates the live-streaming application on the terminal. The following description refers to both of FIGS. 6 and 7. Before the live-streaming application is installed on the user terminal, the user runs a different application program on the user terminal, such as a browser application, a news application, or an SNS application. The different application program causes the display to display a screen including a banner advertisement about the functionality of the live-streaming application (S502). For example, a browser application on the user terminal causes the display to display a browser application screen 602 including a viewing function introducing banner advertisement 604. Alternatively, a news application on the user terminal causes the display to display a news application screen 606 including a streaming function introducing banner advertisement 608. Alternatively, an SNS application on the user terminal causes the display to display an SNS application screen 610 including a premium function introducing banner advertisement 612. The banner advertisements 604, 608 and 612 may be placed by the provider of the live streaming application. In other words, the provider that places the banner advertisements 604, 608 and 612 may be different from the providers of the applications that cause the display to display the banner advertisements 604, 608 and 612.

FIG. 7 describes a case where a banner advertisement is employed as advertisement information about the functionality of the live-streaming application displayed by the different application program. In another embodiment, however, other types of display advertisements than a banner advertisement may be used as the advertisement information. For example, a video advertisement, a text advertisement, and an image advertisement may be used, or other forms of advertising may be employed such as search advertising, in-app advertising, advertising targeting user viewing videos.

If the user is interested in what is offered by the banner advertisement displayed by the different application program, the user designates, for example, taps the banner advertisement. The user terminal accepts the designation of the banner advertisement (S504).

On reception of the designation of the banner advertisement in the step S504, the user terminal downloads and installs the live-streaming application from a download site on itself. (S506). The user terminal may inquire the user if it is acceptable to start downloading the live-streaming application before the start of the downloading. The live-streaming application is thus installed on the user terminal in response to the user tapping the banner advertisement.

The UI control unit 402 of the initial activation processing unit 400 selects, from among a plurality of function introducing screens introducing a plurality of functions of the live-streaming application, a function introducing screen introducing the function corresponding to the banner advertisement designated by the user in the step S504 (S508). The UI control unit 402 causes the display to first display the function introducing screen selected in the step S508, from among the function introducing screens (S510). For example, if the user taps the viewing function introducing banner advertisement 604 on the browser application screen 602, the live-streaming application is first installed on the user terminal and then activated. The first screen displayed after the activation is a viewing function introducing screen 624 corresponding to the viewing function introducing banner advertisement 604. Alternatively, if the user taps the streaming function introducing banner advertisement 608 on the news application screen 606, the live-streaming application is first installed on the user terminal and then activated. The first screen displayed after the activation is a streaming function introducing screen 616 corresponding to the streaming function introducing banner advertisement 608. Alternatively, if the user taps the premium function introducing banner advertisement 612 on the SNS application screen 610, the live-streaming application is first installed on the user terminal and then activated. The first screen displayed after the activation is a premium function introducing screen 620 corresponding to the premium function introducing banner advertisement 612. As noted, the same live-streaming application is installed no matter which banner advertisement is designated, but the first screen displayed after the installment and at the initial activation depends on which one of the banner advertisements is designated.

The above-described series of steps including the tapping of the banner advertisement, the installment of the live-streaming application and the displaying of various function introducing screens may be implemented by, for example, Deferred Deep Link described in “What is Deep Linking in Mobile Apps?” Zhiyi Huang, URL: https://www.adjust.com/ja/blog/dive-into-deeplinking/.

If the user downloads and installs the live-streaming application not by tapping a banner advertisement but by accessing a download site, the UI control unit 402 causes the display to first display a default one of the three function introducing screens at initial activation of the live streaming application. For example, when the user taps an icon 628 indicating the live-streaming application for the first time on a home screen 626 after the installment, the UI control unit 402 causes the display to first display the viewing function introducing screen 624 as a default.

The UI control unit 402 causes a start object to be included in each function introducing screen. For example, a start object 614 with a text “View Now” is placed on the viewing function introducing screen 624. A start object 618 with a text “Stream Now” is placed on the streaming function introducing screen 616. A start object 622 with a text “View Premium” is placed on the premium function introducing screen 620. The start objects 614, 618 and 622 are displayed in different ways from each other. This allows the user to easily understand that the start objects 614, 618 and 622 will redirect the user to different screens.

The UI control unit 402 is configured to detect a swipe on the currently displayed function introducing screen and a tap on the start object included in the currently displayed screen. When detected, a tap on the start object serves as a designation of the start object by the user.

The UI control unit 402 invokes a screen transition between the function introducing screens in response to a swipe or a predetermined user input. The UI control unit 402 determines whether a swipe is detected on the currently displayed function introducing screen (S512). If a swipe is detected (Y in S512), the UI control unit 402 performs a transition between the function introducing screens (S514). For example, if the UI control unit 402 detects a swipe on the currently displayed viewing function introducing screen 624, the UI control unit 402 implements a transition from the viewing function introducing screen 624 to the streaming function introducing screen 616. Alternatively, if the UI control unit 402 detects a swipe on the currently displayed premium function introducing screen 620, the UI control unit 402 causes a transition from the premium function introducing screen 620 to the streaming function introducing screen 616. The process then returns to the step S512.

If a swipe is not detected in the step S512 (N in S512), the UI control unit 402 determines whether a tap is detected on the start object included in the currently displayed function introducing screen (S516). If no tap is detected (N in S516), the process returns to the step S512. If a tap is detected (Y in S516), the UI control unit 402 registers, in the selection result holding unit 500, identification information identifying the function corresponding to the function introducing screen displayed on the display when the tap on the start object is detected in the step S516 (S518). In this case, the identification information identifies the function corresponding to the function introducing screen including the start object designated by the user in the step S516. The user registration unit 404 handles user registration if atap is detected in the step S516 (S520). As noted above, the user registration may be handled using known techniques.

Once the user registration is completed in the step S520, the initial screen selecting unit 406 selects, from among a plurality of function screens corresponding to a plurality of functions provided by the live-streaming application, a function screen corresponding to the function identified by the identification information held in the selection result holding unit 500 (S522). The function screens are configured to allow the user to use the respective functions of the live-streaming applications. The UI control unit 402 causes the display to first display the function screen selected in the step S522, from among the function screens (S524). The first function screen displayed is the function screen configured to allow the user to use the function corresponding to the function introducing screen including the start object designated by the user in the step S516.

For example, if the start object 614 is tapped on the viewing function introducing screen 624, the function ID identifying the viewing function introduced on the viewing function introducing screen 624 is registered in the selection result holding unit 500, and user registration is also performed. Once the user registration is completed, an initial screen selecting process is performed to retrieve the function ID from the selection result holding unit 500, and a by-genre live stream selection screen 630 is first displayed on the display that allows the user to use the viewing function identified by the retrieved function ID. Alternatively, if the start object 618 is tapped on the streaming function introducing screen 616, a function ID identifying the streaming function introduced by the streaming function introducing screen 616 is registered in the selection result holding unit 500, and user registration is also performed. Once the user registration is completed, an initial screen selecting process is performed to retrieve the function ID from the selection result holding unit 500, and a streaming setting screen 632 is first displayed on the display that allows the user to use the streaming function identified by the retrieved function ID. Alternatively, if the start object 622 is tapped on the premium function introducing screen 620, a function ID identifying the premium viewing function introduced by the premium function introducing screen 620 is registered in the selection result holding unit 500, and user registration is also performed. Once the user registration is completed, an initial screen selecting process is performed to retrieve the function ID from the selection result holding unit 500, and a premium viewing screen 634 is first displayed on the display that allows the user to use the premium viewing function identified by the retrieved function ID.

In the above embodiment, the live-streaming system 1 may comprise a holding unit for storing various information used for the service provided by the live-streaming system 1. An example of the holding unit includes a hard disk or semiconductor memory. It is understood by those skilled in the art that each element or component can be realized by a CPU not shown, a module of an installed application program, a module of a system program, or a semiconductor memory that temporarily stores the contents of data read from a hard disk, and the like.

The live-streaming system 1 according to the present embodiment can provide a customer flow from an introduction of a function presented as part of a value proposition to a landing page that allows the user to use the corresponding function. This can swiftly satisfy the expectation of the user who has installed the live-streaming application. The user can more smoothly start using the live-streaming application.

The live-streaming application can provide various functions including viewing and streaming functions, and prospective users who desire to install and use the live-streaming application also have various expectations and purposes. To address this issue, the live-streaming system 1 relating to the present embodiment can provide introducing screens corresponding to the respective functions of the live-streaming application, so that the user can be guided from each introducing screen to the corresponding landing page (function screen). This can improve the usability, thereby preventing the user from abandoning the live-streaming application.

The live-streaming system 1 according to the present embodiment can provide a customer flow from an introduction of a function presented as part of an advertisement to a value proposition page for the function (function introducing screen). This can result in swiftly providing the user with information about the function of the live-streaming application in which the user is interested in. As a result, the users can be more smoothly guided to the user registration.

For example, the user may learn from a banner advertisement that his or her favorite celebrity is live-streaming and tap the banner advertisement. After installing the live-streaming application, the user can reach a value proposition page introducing the celebrity's live-streaming. The user may read the page to know what the live-streaming is about and tap a start object. In this case, after user registration, the user can be guided to a premium viewing screen that enables the user to view the celebrity's live streaming. In this way, the user can enjoy experience tailored to the user's initial expectations and interests.

### <Hardware Configuration>

Referring to FIG. 8, the hardware configuration of an information processing device will be now described. FIG. 8 is a block diagram showing an example of the hardware configuration of an information processing device according to the embodiment. The illustrated information processing device 900 may, for example, realize the server 10 and the user terminals 20 and 30 in the embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the embodiment. The ROM 902 stores programs including sets of instructions, calculation parameters, and the like used by the CPU 901. The RAM 903 serves as a primary storage that stores programs including sets of instructions used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the live-streaming system 1 in the embodiment have been described. Those skilled in the art will understand that this embodiment is a merely example, that various modifications are possible for combinations of the components and processes, and that such modifications are also within the scope of the present disclosure.

In the above embodiment, the functions provided by the live-streaming application include the viewing, streaming and premium viewing functions. The present embodiment, however, is not limited to such. The functions can include other functions such as event and multi-distributor functions.

In the embodiment described above, the user registration starts once the user taps the start object on the function introducing screen. The present embodiment, however, is not limited to such. For example, after the user taps the banner advertisement and completes the installation of the live-streaming application, the user registration may be performed before the function introducing screen is displayed. In this case, it is no longer necessary to hold the identification information in the selection result holding unit 500, and the start object of each function introducing screen may contain a link to the corresponding function screen.

The technical idea according to the embodiment may be applied to live commerce or virtual live-streaming using an avatar that moves in synchronization with the movement of the distributor instead of the image of the distributor.

The procedures described herein, particularly those described with a flow diagram, a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

At least some of the functions realized by the server may be realized by a device(s) other than the server, for example, the user terminals. At least some of the functions realized by the user terminals may be realized by a device(s) other than the user terminals, for example, the server. For example, the superimposition of a predetermined frame image on an image of the video data performed by the user terminal where the video data is reproduced may be performed by the server 10 or may be performed by the user terminal where the video data is generated.

What is claimed is:

1. A terminal, comprising:
one or more processors; and
a memory storing one or more sets of instructions configured to be executed by the one or more processors for triggering an initial activation of an application program after the application program is installed on the terminal, wherein the initial activation comprises:
selecting a first function introducing screen used to introduce a designated function from a plurality of function introducing screens corresponding to a plurality of functions of the application program and displaying only the first function introducing screen on a display of the terminal as a currently displayed screen, wherein the designated function is designated by a user upon installation of the application program and the first function introducing screen is selected based on the designated function;
upon detection of a swipe on the currently displayed screen, transitioning the currently displayed screen from the first function introducing screen to a second function introducing screen selected from the plurality of function introducing screens, wherein the first function introducing screen and the second function introducing screen include different start objects and introduce different functions of the application program; and
upon detection of a tap on a start object included in the currently displayed screen, displaying on the display a function screen that enables the user to use the function corresponding to the currently displayed screen that includes the start object being tapped.

2. The terminal of claim 1,
wherein the application program is installed on the terminal in response to the user of the terminal designating an advertisement included in a screen of a different program executed by the terminal,
wherein the advertisement introduces the designated function corresponding to the first introducing screen.

3. The terminal of claim 2,
wherein the advertisement comprises a viewing function introducing banner advertisement or a streaming function introducing banner advertisement, wherein the first function introducing screen is a viewing function introducing screen and the designated function is a viewing function of a livestream if the advertisement comprises the viewing function introducing banner advertisement, and the first function introducing screen is a streaming function introducing screen and the designated function is a streaming function of the livestream if the advertisement comprises the streaming function introducing banner advertisement.

4. The terminal of claim 1,
wherein the initial activation further comprises:
detecting that the start object included in the currently displayed screen is tapped;
registering in a holding unit identification information identifying the function corresponding to the currently displayed screen; and
handling user registration of the user in a user registration unit;
wherein the displaying on the display the function screen includes, on completion of the user registration, retrieving the identification information from the holding unit and selecting the function screen corresponding to the function identified by the identification information.

5. The terminal of claim 1, wherein the one or more sets of instructions further configured to be executed by the one or more processors for, before the initial activation of the application program:
running a different program to cause the display of the terminal to display a screen including an advertisement showing the designated function of the application program; and
downloading and installing the application program on the terminal when the advertisement included in the screen is tapped;
wherein the first function introducing screen is selected from the plurality of function introducing screens based on the designated function shown in the advertisement being tapped.

6. A method comprising:
at an initial activation of an application program after the application program is installed on a terminal,
selecting a first function introducing screen used to introduce a designated function from a plurality of function introducing screens corresponding to a plurality of functions of the application program and displaying only the first function introducing screen on a display of the terminal as a currently displayed screen, wherein the designated function is designated by a user upon installation of the application program and the first function introducing screen is selected based on the designated function;
upon detection of a swipe on the currently displayed screen, transitioning the currently displayed screen from the first function introducing screen to a second function introducing screen selected from the plurality of function introducing screens, wherein the first function introducing screen and the second function introducing screen include different start objects and introduce different functions of the application program; and
upon detection of a tap on a start object included in the currently displayed screen, displaying on the display a function screen that enables the user to use the function corresponding to the currently displayed screen that includes the start object being tapped.

7. The method of claim 6, further comprising:
Installing the application program on the terminal in response to the user of the terminal designating an advertisement included in a screen of a different program executed by the terminal,
wherein the advertisement introduces the designated function corresponding to the first introducing screen.

8. The method of claim 7,
wherein the advertisement comprises a viewing function introducing banner advertisement or a streaming function introducing banner advertisement, wherein the first function introducing screen is a viewing function introducing screen and the designated function is a viewing function of a livestream if the advertisement comprises the viewing function introducing banner advertisement, and the first function introducing screen is a streaming function introducing screen and the designated function is a streaming function of the livestream if the advertisement comprises the streaming function introducing banner advertisement.

9. The method of claim 6, further comprising:
detecting that the start object included in the currently displayed screen is tapped;
registering in a holding unit identification information identifying the function corresponding to the currently displayed screen; and
handling user registration of the user in a user registration unit;
wherein the displaying on the display the function screen includes, on completion of the user registration, retrieving the identification information from the holding unit and selecting the function screen corresponding to the function identified by the identification information.

10. The terminal of claim 6, further comprising following steps before the initial activation of the application program:
running a different program to cause the display of the terminal to display a screen including an advertisement showing the designated function of the application program; and
downloading and installing the application program on the terminal when the advertisement included in the screen is tapped;
wherein the first function introducing screen is selected from the plurality of function introducing screens based on the designated function shown in the advertisement being tapped.

11. A terminal on which an application program is installed in response to a user designating an advertisement showing a first function of a plurality of functions of the application program displayed on a screen of a different program executed by the terminal, comprising:
one or more processors; and
a memory storing one or more sets of instructions configured to be executed by the one or more processors for:
at an initial activation of the application program after the application program is installed on the terminal,
directly displaying, on a display of the terminal, a first function introducing screen that introduces the first function shown in the advertisement being designated upon installing the application program on the terminal;
in response to a swipe made by the user on the first function introducing screen, causing a transition to switch the display from only displaying the first function introducing screen to only displaying a second function introducing screen, wherein the second function introducing screen introduces a second function of the application program and the second function is different from the first function; and
in response to a tapping made by the user on either the first function introducing screen or the second function introducing screen, displaying, on the display of the terminal, a function screen that enables the user to use the first function or the second function of the application program.
